(19) United States
(12) Patent Application Publication
(10) Pub. No.: US 2025/0236304 A1
(43) Pub. Date: Jul. 24, 2025

(54) Steering System, Vehicle Comprising Steering System and Method of Operating Steering System

(71) Applicant: Robert Bosch GmbH, Stuttgart (DE)

(72) Inventor: Roland Greul, Schwaebisch Gmeund (DE)

(21) Appl. No.: 19/018,846

(22) Filed: Jan. 13, 2025

(30) Foreign Application Priority Data
Jan. 18, 2024 (DE) 10 2024 200 445.6

(51) Int. Cl. B60W 50/02; B60W 10/18; B60W 10/20

(52) U.S. Cl. CPC B60W 50/0205; B60W 10/18; B60W 10/20; B60W 2520/125; B60W 2520/14

(57) ABSTRACT

A steering system includes a steering angle actuator for detecting a steering request and a steering actuator for moving steered wheels of the vehicle. In the event of a failure of the steering actuator, lateral control of the vehicle is carried out by means of a brake and/or a drive and/or rear axle steering system of the vehicle, in particular based on sensor information which describes a driving dynamics of the vehicle, preferably based on a yaw rate and/or lateral acceleration, wherein a deviation between the steering request and a steering movement achieved by the lateral control is detected, and wherein the deviation is reported back to a driver via the steering angle actuator.

This application claims priority under 35 U.S.C. § 119 to application no. DE 10 2024 200 445.6, filed on Jan. 18, 2024 in Germany, the disclosure of which is incorporated herein by reference in its entirety.

### BACKGROUND

The disclosure is based on a steering system, a vehicle comprising the steering system, and a method of operating the steering system.

In a steering system with a steering angle actuator for detecting a steering request and a steering actuator for moving the steered wheels of the vehicle, it is possible to influence the steering feel of the driver of the vehicle.

### SUMMARY

With the steering system and the method for operating the steering system of a vehicle according to the disclosure, a steering feel of a driver of the vehicle is meaningfully influenced in the event of a failure of the steering actuator.

The steering system includes a steering angle actuator for detecting a steering request and a steering actuator for moving steered wheels of the vehicle. The method provides that, in the event of a failure of the steering actuator, lateral control of the vehicle is carried out by means of a brake and/or a drive and/or rear axle steering system of the vehicle, in particular based on sensor information describing the driving dynamics of the vehicle, preferably based on a yaw rate and/or lateral acceleration, wherein a deviation between the steering request and a steering movement achieved by the lateral control is detected, and wherein the deviation is reported back to a driver via the steering angle actuator.

It may be provided that the steering angle actuator can be moved up to an end stop, which is reported back to the driver with an end stop torque applied via the steering angle actuator, wherein the end stop torque is adjusted depending on the deviation.

It may be possible to determine the difference between the target yaw rate of the vehicle defined by the steering request and the yaw rate achieved by the lateral control and/or between the target lateral acceleration of the vehicle defined by the steering request and the lateral acceleration achieved by the lateral control.

It may be provided that the end stop torque is determined with a first order of magnitude if the deviation is greater in absolute value than a first threshold value, wherein the end stop torque is determined with a second order of magnitude if the deviation is greater in absolute value than a second threshold value, wherein the first threshold value is smaller than the second threshold value, wherein the second order of magnitude is greater than the first order of magnitude.

It may be required that the deviation be reported back by means of an artificial excitation, in particular a vibration, of the steering angle actuator.

It may be provided that the steering actuator comprises a steering rack for moving the steered wheels, wherein a steering movement provided by the steering actuator is fed back by an artificial excitation of the steering angle actuator, which is determined as a function of a magnitude, provided by the steering actuator, of a steering rack force or a rack torque, wherein in the event of failure of the steering actuator a replacement variable for the variable is determined as a function of sensor information which describes the driving dynamics of the vehicle, preferably based on the yaw rate and/or the lateral acceleration, and the artificial excitation is determined as a function of the replacement variable.

The steering system for the vehicle includes a steering angle actuator for detecting a steering request and a steering actuator for moving steered wheels of the vehicle, wherein the steering system is designed to influence a lateral control of the vehicle by a brake and/or a drive and/or a rear axle steering system of the vehicle, in particular based on sensor information describing a driving dynamic of the vehicle, preferably based on a yaw rate and/or lateral acceleration, in the event of a failure of the steering actuator, to detect a deviation between the steering request and a steering movement achieved by the lateral control, and to report the deviation back to a driver via the steering angle actuator.

It may be provided that the steering angle actuator can be moved up to an end stop, wherein the steering system is designed to report the end stop back to the driver with an end stop torque applied to the steering angle actuator, and to adjust the end stop torque depending on the deviation.

It may be provided that the steering system is designed to determine the deviation between a target yaw rate of the vehicle defined by the steering request and a yaw rate achieved by the lateral control and/or between a target lateral acceleration of the vehicle defined by the steering request and a lateral acceleration achieved by the lateral control.

It may be provided that the steering system is designed to determine the end stop torque with a first order of magnitude if the deviation is greater in absolute value than a first threshold value, and to determine the end stop torque with a second order of magnitude if the deviation is greater in absolute value than a second threshold value, wherein the first threshold value is smaller than the second threshold value, wherein the second order of magnitude is greater than the first order of magnitude.

It may be stipulated that the steering system is designed to report the deviation by means of an artificial excitation, in particular a vibration, of the steering angle actuator.

It may be provided that the steering actuator comprises a steering rack for moving the steered wheels, wherein the steering system is adapted to feedback a steering movement provided by the steering actuator by an artificial excitation of the steering angle actuator, which is determined depending on a quantity of a steering rack force or a steering rack torque provided by the steering actuator, and, in the event of failure of the steering actuator, to determine a replacement variable for the variable as a function of sensor information describing the driving dynamics of the vehicle, preferably based on the yaw rate and/or the lateral acceleration, and to determine the artificial excitation as a function of the replacement variable.

A vehicle that encompasses the vehicle's steering system has corresponding advantages.

### BRIEF DESCRIPTION OF THE DRAWINGS

Further advantageous embodiments will become apparent from the following description and the drawing. The drawings show:

FIG. 1 a schematic representation of a vehicle with a steering system.

FIG. 2 a flow chart showing the steps of a method for operating the steering system.

### DETAILED DESCRIPTION

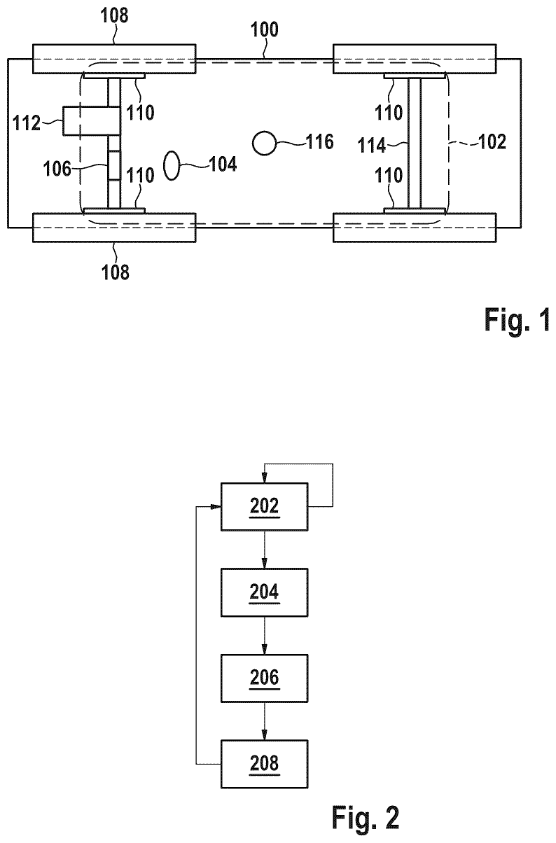

A vehicle 100 having a steering system 102 is shown schematically in FIG. 1. The steering system 102 is, for example, a steer-by-wire steering system.

The steering system 102 includes a steering angle actuator 104 and a steering actuator.

The steering angle actuator 104 is designed to detect a steering request from a driver of the vehicle 100.

The steering angle actuator 104 is designed to provide feedback to the driver regarding the steering behavior of the vehicle 100.

The steering angle actuator 104 includes, for example, a steering wheel or a joystick.

The steering angle actuator 104 can be moved up to an end stop. In one example, the steering system 102 is configured to report the end stop to the driver by means of an end stop torque applied via the steering angle actuator 104.

Steering actuator 106 is configured to move steered wheels 108 of vehicle 100.

In the example, the steering actuator 106 includes a steering rack that is moved by the steering actuator with a steering rack force or a steering rack torque.

If the steering actuator 106 fails, it is impossible to directly influence the steered wheels 108 with the steering actuator 106. In the example, the steering angle actuator 104 is functional independently of the steering actuator 106.

The steering system 102 is designed to influence a lateral control of the vehicle 100 by means of a brake 110 and/or a drive 112 and/or a rear axle steering system 114 of the vehicle 100 in the event of a failure of the steering actuator 106.

The steering system 102 is designed to influence the lateral control based on sensor information that describes the driving dynamics of the vehicle 100. The sensor information is, for example, a yaw rate and/or lateral acceleration of vehicle 100. In the example, the vehicle 100 includes a sensor 116 that is designed to capture the sensor information, i.e. the yaw rate and/or lateral acceleration, for example.

The steering system 102 is designed to detect a deviation between the steering request and a steering movement achieved by the lateral control.

The steering system 102 is designed to report the deviation to a driver via the steering angle actuator 104. The steering system 102 is designed, for example, to report the deviation by means of an artificial excitation, in particular a vibration, of the steering angle actuator 104.

The steering system 102 is designed, for example, to report back a steering movement made by the steering actuator 106 by artificially excitation the steering angle actuator 104, which is determined depending on a variable of a steering rack force or a steering rack torque set by the steering actuator 106.

The steering system 102 is designed, for example, to determine a replacement variable for the variable in the event of a failure of the steering actuator 106, depending on sensor information that describes the driving dynamics of the vehicle 100, and to determine the artificial excitation depending on the replacement variable. The steering system 102 is designed, for example, to determine the replacement variable based on the yaw rate and/or the lateral acceleration.

It may be the case that the control system 102 is designed to adjust the end stop torque depending on the deviation.

The steering system 102 is designed to determine the deviation between a target yaw rate of the vehicle defined by the steering request and a yaw rate achieved by the lateral control.

The steering system 102 is designed to determine the deviation between a target lateral acceleration of the vehicle defined by the steering request and a lateral acceleration achieved by the lateral control.

The steering system 102 is embodied in an example that determines the deviation as a function of a weighted sum, in particular, of the deviation between the target yaw rate of the vehicle, as defined by the steering request, and the yaw rate achieved by the lateral control, and the deviation between the target lateral acceleration of the vehicle, as defined by the steering request, and the lateral acceleration achieved by the lateral control.

The steering system 102 can be designed to determine the end stop torque with a first order of magnitude if the deviation is greater in absolute value than a first threshold value.

The steering system 102 can be designed to determine the end stop torque with a second order of magnitude if the deviation is greater in absolute value than a second threshold value.

In the example, the first threshold is smaller than the second threshold. In the example, the second order of magnitude is larger than the first order of magnitude.

FIG. 2 shows a flowchart with steps of a method for operating the steering system 102. The steering system 102 includes, for example, a computing device designed to execute the method.

The method comprises a step 202.

In step 202, the steering angle actuator 104 is used to detect a steering request, and the steering actuator 106 is used to move the steering rack to turn the steered wheels 108 in accordance with the steering request.

The steering movement provided by the steering actuator 106 is reported back, for example, by the artificial excitation of the steering angle actuator 104, which is determined depending on the magnitude of the rack force or the rack torque provided by the steering actuator 106.

In step 202, a check is made to see whether or not the steering actuator 106 has failed. If there is a failure of the steering actuator 106, a step 204 is executed. Otherwise, step 202 is executed.

In step 204, the lateral control of the vehicle 100 is influenced by the brake 110 and/or the drive 112 and/or the rear axle steering system 114 of the vehicle 100.

The lateral control is influenced, for example, based on sensor information that describes the driving dynamics of the vehicle 100.

In the example, lateral control is based on the yaw rate and/or lateral acceleration.

For example, a target yaw rate \dot{φ}_{target} is calculated from a steering angle detected at the steering angle actuator 104 with a steering ratio, in particular a variable steering ratio, and adjusted by remaining actuators, e.g. brake 110, drive 112, rear axle steering system 114, in comparison with a measured actual yaw rate \dot{φ}_{actual}.

For example, a steering angle detected at the steering angle actuator 104 is used to calculate a target lateral acceleration a_{y}^{target}, in particular with a variable steering ratio, and this is adjusted by the remaining actuators in comparison with a measured actual lateral acceleration a_{y}^{actual}.

The method comprises a step 206.

In step 206, the deviation between the steering request and the steering movement achieved by the lateral control is recorded.

It may be possible to adjust the end stop torque depending on the deviation.

The method comprises a step 208.

In step 208, the deviation is reported back to the driver via the steering angle actuator 104. The deviation is reported back, e.g. by means of artificial excitation, in particular vibration, of the steering angle actuator 104.

The artificial excitation of the steering angle actuator 104 is determined, for example, depending on the sensor information that describes the driving dynamics of the vehicle 100, in the event of a failure of the steering actuator 106.

The artificial excitation is determined, for example, based on the replacement variable for the size.

The replacement variable is determined, for example, depending on the yaw rate. The replacement variable is determined, for example, depending on the lateral acceleration. The replacement variable is determined, for example, depending on the yaw rate and the lateral acceleration.

It may be stipulated that the replacement variable is determined depending on the deviation of the actual yaw rate \dot{φ}_{actual} from the target yaw rate \dot{φ}_{target}.

It may be stipulated that the replacement variable is determined depending on the deviation of the actual lateral acceleration a_{y}^{actual} from the target lateral acceleration a_{y}^{target}.

For the magnitude of the rack force F_{Z}, for example, the replacement variable F_{Z}^{e} of the rack force is determined as follows:

$${F}_{Z}^{e} = {K}_{\dot{φ}} ( {v}_{x} ) ( {\dot{φ}}_{target} - {\dot{φ}}_{actual} ) + {K}_{{a}_{y}} ( {v}_{x} ) ( {a}_{y}^{target} - {a}_{y}^{actual} )$$

wherein K_{\dot{φ}}(vₓ) and Kₐ_{_{y}}(vₓ) each denote an optional weighting factor dependent on a longitudinal speed vₓ of the vehicle 100.

It may be provided that the end stop is reported back to the driver via the end stop torque set by the steering angle actuator 104.

The end stop torque is determined, for example, with the first order if the deviation is greater in absolute value than the first threshold value.

The end stop torque is determined, for example, with the second order if the deviation is greater in absolute value than the second threshold.

The end stop is applied, for example, at the point where a large and rapidly increasing yaw rate deviation, or a comparable driving dynamics variable, indicates that a limit to the lateral control potential has been reached via the remaining actuators.

In the example, the applied end stop torque takes on the first order of magnitude due to the first threshold value Threshold_1. For the yaw rate, for example:

$$\vert ( {\dot{φ}}_{target} - {\dot{φ}}_{actual} ) \vert \geq Threshold\_ 1$$

In the example, the second threshold value Threshold_2 is used to set a maximum end stop torque. For the yaw rate, for example:

$$\vert ( {\dot{φ}}_{target} - {\dot{φ}}_{actual} ) \vert \geq Threshold\_ 2$$

This means that even at this lower level, the driver still has a sense of control over the steering.

After that, step 202 is executed.

1. A method for operating a steering system of a vehicle, the steering system including a steering angle actuator for detecting a steering request and a steering actuator for moving steered wheels of the vehicle, the method comprising:
in response to a failure of the steering actuator, carrying out lateral control of the vehicle via at least one of a brake, a drive, and a rear axle steering system of the vehicle;
detecting a deviation between the steering request and a steering movement achieved by the lateral control; and
reporting the deviation back to a driver via the steering angle actuator.

2. The method according to claim 1, wherein the carrying out the lateral control of the vehicle is based on sensor information that describes driving dynamics of the vehicle.

3. The method according to claim 2, wherein the sensor information that describes the driving dynamics of the vehicle is based on a yaw rate and/or lateral acceleration.

4. The method according to claim 1, wherein the steering angle actuator is movable up to an end stop, the method further comprising:
reporting reaching the end stop back to the driver with an end stop torque set via the steering angle actuator; and
adjusting the end stop torque depending on the deviation.

5. The method according to claim 4, wherein the detecting of the deviation includes detecting at least one of (i) a deviation between a target yaw rate of the vehicle defined by the steering request and a yaw rate achieved by the lateral control and/or (ii) a deviation between a target lateral acceleration of the vehicle defined by the steering request and a lateral acceleration achieved by the lateral control.

6. The method according to claim 5, wherein:
the end stop torque is determined with a first order of magnitude if the deviation is greater in absolute value than a first threshold value,
the end stop torque is determined with a second order of magnitude if the deviation is greater in absolute value than a second threshold value,
the first threshold value is smaller than the second threshold value, and
the second order of magnitude is greater than the first order of magnitude.

7. The method according to claim 1, wherein the reporting the deviation back to the driver includes feeding back the deviation to the steering angle actuator via a first artificial excitation of the steering angle actuator.

8. The method according to claim 7, wherein the artificial excitation is a vibration of the steering angle actuator.

9. The method according to claim 7, wherein the steering actuator comprises a rack for moving the steered wheels, and a steering movement provided by the steering actuator is fed back by a second artificial excitation of the steering angle actuator, which is determined depending on a quantity of a rack force or a rack torque provided by the steering actuator, the method further comprising:
in response to the failure of the steering actuator, determining a replacement variable for the variable as a function of sensor information which describes driving dynamics of the vehicle; and
determining the first artificial excitation as a function of the replacement variable.

10. The method according to claim 9, wherein the determining of the replacement variable for the variable is based on a yaw rate and/or a lateral acceleration.

11. A steering system for a vehicle, comprising:
a steering angle actuator configured to detect a steering request; and
a steering actuator configured to move steered wheels of the vehicle,
wherein, in response to a failure of the steering actuator, the steering system is configured to:
provide lateral control of the vehicle via at least one of a brake, a drive, and a rear axle steering system of the vehicle;
detect a deviation between the steering request and a steering movement achieved by the lateral control; and
report the deviation back to a driver via the steering angle actuator.

12. The steering system according to claim 11, wherein the providing of the lateral control of the vehicle is based on sensor information that describes driving dynamics of the vehicle.

13. The steering system according to claim 12, wherein the sensor information that describes the driving dynamics of the vehicle is based on a yaw rate and/or lateral acceleration.

14. The steering system according to claim 11, wherein the steering angle actuator is movable up to an end stop, and the steering system is further configured to report the end stop back to the driver via an end stop torque set via the steering angle actuator, and to adapt the end stop torque as a function of the deviation between the steering request and a steering movement achieved by the lateral control.

15. The steering system according to claim 14, wherein the steering system is further configured to determine the deviation (i) between a target yaw rate of the vehicle, which is defined by the steering request, and a yaw rate achieved by the lateral control, and/or (ii) between a target lateral acceleration of the vehicle, which is defined by the steering request, and a lateral acceleration achieved by the lateral control.

16. The steering system according to claim 15, wherein:
the steering system is further configured to:
determine the end stop torque with a first order of magnitude if the deviation is greater in absolute value than a first threshold value, and
determine the end stop torque with a second order of magnitude if the deviation is greater in absolute value than a second threshold value, and
the first threshold value is smaller than the second threshold value, and the second order of magnitude is greater than the first order of magnitude.

17. The steering system according to claim 11, wherein the steering system is configured to report the deviation via an artificial excitation of the steering angle actuator.

18. The steering system according to claim 17, wherein the artificial excitation is a vibration of the steering angle actuator.

19. The steering system according to claim 11, wherein:
the steering actuator comprises a rack for moving the steered wheels,
the steering system is further configured to report back a steering movement provided by the steering actuator via an artificial excitation of the steering angle actuator, which is determined as a function of a variable of a rack force or a rack torque provided by the steering actuator, and
in response to the failure of the steering actuator, the steering system is further configured to determine a replacement variable for the variable as a function of sensor information describing driving dynamics of the vehicle and to determine the artificial excitation as a function of the replacement variable.

20. A vehicle comprising:
the steering system according to claim 11.
